(19) United States
(12) Patent Application Publication
(10) Pub. No.: US 2010/0320924 A1
(43) Pub. Date: Dec. 23, 2010

(54) DEVICE FOR CONTROLLING A DISCHARGE LAMP

(75) Inventor: Marcel Beij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/866,303

(22) PCT Filed: Feb. 5, 2009
(86) PCT No.: PCT/IB2009/050466

§ 371 Date: Aug. 5, 2010

(30) Foreign Application Priority Data
Feb. 14, 2008 (EP) 08151427.5

(51) Int. Cl. H05B 41/36

(52) U.S. Cl. 315/224

(57) ABSTRACT

An electro magnetic ballast (110; 210) for a gas discharge lamp (2) comprises: input terminals (3), for receiving a mains voltage; lamp connector terminals (4), for receiving a lamp; an impedance connected in series with the lamp connector terminals, the impedance comprising at least an inductor (L) and preferably comprising a series arrangement of a capacitor (C) and an inductor (L); and an electronic switching circuit (120; 220) having input terminals (22, 23) connected in parallel to the lamp connector terminals. The electronic switching circuit comprises:—rectifier (21) connected to the input terminals (22, 23) and having a positive output terminal (24) and a negative output terminal (25); switchable voltage clamping and energy dissipating means (126, 127; 26, 27, 227, 230) connected between said positive output terminal (24) and said negative output terminal (25);—and a control circuit (28) for controlling the voltage clamping and energy dissipating means.

### FIELD OF THE INVENTION

The present invention relates in general to the switching of discharge lamps.

### BACKGROUND OF THE INVENTION

It is generally known that gas discharge lamps, for example the well-known TL-lamps, are driven by an electro magnetic ballast (EM ballast). FIG. 1 is a schematic block diagram, illustrating such conventional EM ballast 1 for a lamp 2. The ballast 1 of this example comprises an inductor L and a capacitor C in series with the lamp 2 to be driven, and a mechanical switch S in parallel to the lamp, typically of a bimetal design. The ballast 1 further has input terminals 3 for connection to mains, typically 230 V 50 Hz voltage in Europe. Lamp connector terminals are indicated at 4. In the case of such conventional ballast, the lamp can only be switched ON and OFF by switching the mains.

In a more sophisticated design, the mechanical switch is replaced by a controllable semiconductor switch, operated by an intelligent control device such as for instance a controller. FIG. 2 is a schematic block diagram, illustrating such ballast 10. Compared to the example of FIG. 1, the mechanical switch S has been replaced by an electronic switching circuit 20. This electronic switching circuit 20 comprises a full-wave rectifier 21 (shown as a four-diode bridge) having input terminals 22, 23 connected in parallel to the lamp 2, and having a positive output terminal 24 an a negative output terminal 25. The electronic switching circuit 20 further comprises an electronic switch 26, shown as a MOSFET, connected between the positive and negative terminals 24, 25.

The electronic switching circuit 20 further comprises a control device 28, having a control output connected to the control terminal of the switch 26. The control device 28 may derive its power from the terminals 24, 25, or may derive its power from an external circuit (not shown). The control device 28 may be responsive to external command signals, transmitted over an external circuit (not shown), via a wired or wireless link, e.g. RF.

In normal operation, the switch 26 is non-conductive, and the lamp 2 is powered from the mains. It remains possible for a user to switch off the lamp 2 by switching the mains. If the control device 28 wishes to switch off the lamp 2 without disconnecting the mains, it generates a control signal for the switch 26 such as to render the switch 26 conductive. As a consequence, the switch effectively shorts the lamp 2 so that the current will pass through the switch 26 instead of through the lamp 2, causing the lamp 2 to extinguish. After some time, the plasma in the lamp has disappeared, so that the lamp is no longer conductive. The control device 28 then generates a control signal for the switch 26 such as to render the switch 26 non-conductive again, so that the current flow stops. The control device 28 may render the switch 26 non-conductive again a fixed time delay after having made the switch 26 conductive, but this time-delay may also be adaptive.

It is also possible for the control device 28 to temporarily close and re-open the switch 26 in order to achieve lamp ignition. The distinction between lamp ignition and lamp extinction is mainly determined by the timing, i.e. relative phase, of the closing/opening of the switch 26, as will be clear to a person skilled in the art and disclosed in GB-2.155.258. For allowing the control device 28 to implement a correct timing, the control device 28 inter alia receives a signal indicating momentary current magnitude from a current sensor. In the example of FIG. 2, such current sensor is implemented as a diode 27 coupled in series with the switch 26. The measuring signal, i.e. the voltage developed over the diode, is communicated to the control device 28 via a signal line that is not shown for sake of simplicity.

### SUMMARY OF THE INVENTION

Basically, there can be distinguished two types of ballast, i.e. inductive types and capacitive types. In a ballast of the inductive type, the impedance of the ballast is inductive at the mains frequency; for instance, the capacitor C may be absent. In such case, the device as described above functions to satisfaction. It is noted that said document GB-2.155.258 only discloses a ballast of inductive type; in such case, the switch will be rendered non-conductive again at a zero-crossing of the current.

In a ballast of the capacitive type, the impedance of the ballast at the mains frequency is mainly capacitive. It is noted that said document GB-2.155.258 does not give any suggestion as to how the lamp can be switched off in the case of a ballast of the capacitive type. It is not simply possible to use its teaching regarding an inductive ballast: when the current is zero, the capacitor voltage is maximal, and this can easily be in the order of a few hundred Volts; thus, if the switch would be rendered non-conductive again at a zero-crossing of the current, the lamp receives the mains voltage added to said capacitor voltage, and it may be that this combination exceeds the lamp's re-ignition voltage, in which case the lamp will switch on again.

This is undesirable.

An object of the present invention is to provide a ballast with an electronic switching circuit wherein the above-mentioned problems are overcome.

In one aspect, the present invention provides switchable energy dissipating means connected between said positive output terminal and said negative output terminal of the electronic switching circuit, and a control circuit for controlling the energy dissipating means.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a schematic block diagram illustrating a conventional EM ballast with a mechanical switch;

FIG. 2 is a schematic block diagram illustrating an EM ballast with a controllable semiconductor switch;

FIG. 3 is a schematic block diagram illustrating a first embodiment of a ballast according to the present invention;

FIG. 4 is a schematic block diagram illustrating a second embodiment of a ballast according to the present invention.

FIG. 5 is a graph illustrating behavior of current and voltage when switching in accordance with the present invention.

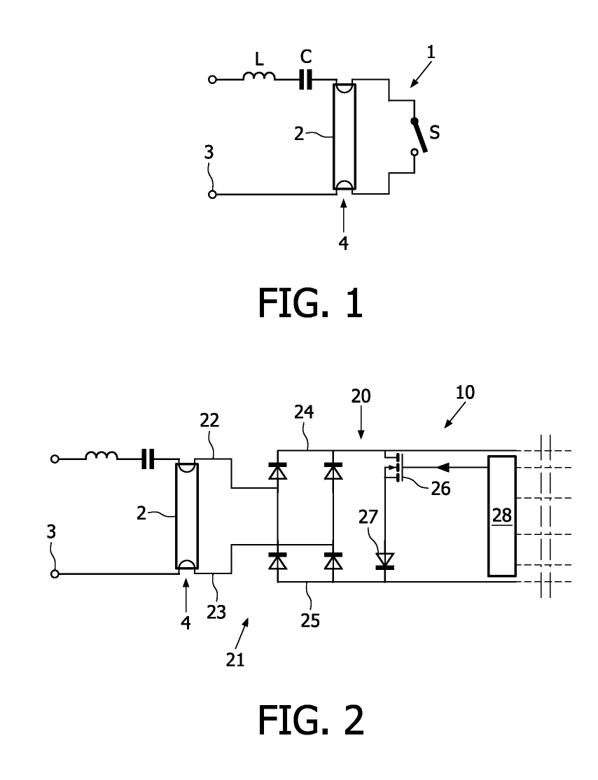

### DETAILED DESCRIPTION OF THE INVENTION

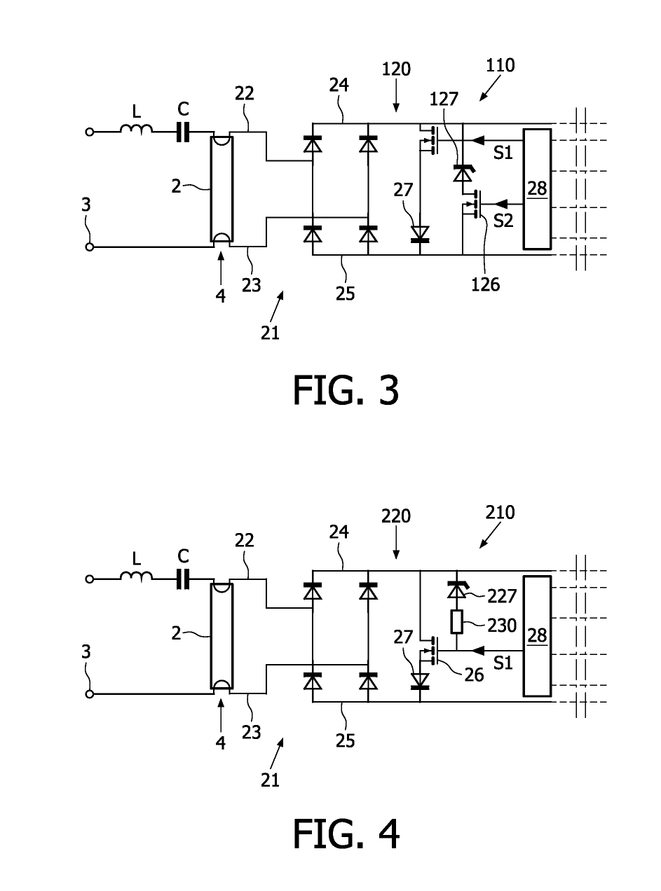

FIG. 3 is a block diagram schematically illustrating a first embodiment of a ballast according to the present invention, generally indicated by the reference numeral 110, having an electronic switching circuit 120, which comprises all elements of the circuit 20 as described above, plus additionally a second controllable switch 126 connected in parallel to the first switch 26 between the positive and negative terminals 24, 25. The control device 28 has a second control output connected to the control terminal of the second switch 126. A Zener diode 127 is connected in series with the second switch 126. The Zener diode 127 is selected to have a Zener voltage higher than the mains voltage amplitude but lower than the ignition voltage of the lamp; in a suitable example, the Zener voltage is about 360-400 V. Although not essential, it is preferred that the Zener diode 127 is positioned between the second switch 126 and the positive terminal 24, as shown.

The control device 28 is capable of operating in a lamp-extinguishing mode. The operation is as follows. Assume that the control device 28 decides, perhaps in response to a user command, to switch off the lamp 2. To this end, in a first step at time t0, the control device 28 generates a first control signal S1 for the first switch 26 to render the first switch 26 conductive. Simultaneously, or somewhat later at a time t1, the control device 28 generates a second control signal S2 for the second switch 126 to render the second switch 126 conductive. Thus, at least from time t1, the switches 26 and 126 are both conductive. However, the Zener diode 127 will not be conductive and the current will be conducted by the first switch 26 only, as described in the above. The lamp will extinguish, also as described in the above.

In a second step at a later time t2, the control device 28 changes its first control signal S1 for the first switch 26 to render the first switch 26 non-conductive again, but maintains the second control signal S2 for the second switch 126 to keep the second switch 126 conductive. The control device 28 is programmed to set the timing t2 in relation to the voltage over the capacitor C. For being able to set the correct timing, the control device 28 is associated with a memory containing relevant information on the behavior of the circuit, and receives a signal indicating the momentary current phase (i.e. the output signal from diode 27) or voltage phase, as will be clear to a person skilled in the art.

In an embodiment, the control device 28 may set the timing t2 such that the voltage over the capacitor C at that time t2 is equal to zero. In that case, the current through inductor L will have a maximum at time t2, i.e. the inductor L contains energy, the amount depending inter alia on the current magnitude at time t2. The current in the inductor L continues to flow, but decreases, while causing an increasing voltage over the capacitor C. The voltage over the lamp electrodes will be equal to the mains voltage plus the voltage over the capacitor C. As long as the rectified voltage over the lamp terminals remains lower than the Zener voltage (and hence lower than the lamp ignition voltage), no current will flow through the second switch 126. If at any time the rectified voltage over the lamp terminals would tend to exceed the Zener voltage, the Zener diode, being subjected to this voltage in view of the second switch 126 being conductive, would become conductive and a current will flow through the second switch 126 and will be dissipated in the Zener diode such that the lamp voltage will be effectively clamped to the Zener voltage. Consequently, the rectified voltage over the lamp terminals remains lower than the lamp ignition voltage, i.e. lamp ignition will be prevented. Further, effectively, there will be energy drained from the capacitor, dissipated by the Zener diode 127.

In a third step at yet a later time t3, the control device 28 changes its second control signal S2 for the second switch 126 to render the second switch 126 non-conductive again. A suitable value for t3 may depend on the current magnitude at time t2, and thus on the exact choice of time t2. A designer may build-in a safety margin, so that t3 is selected later. As such, the exact value of t3 is not critical for the present invention. In fact, it is even possible that the second switch 126 is maintained conductive until it is desired to switch the lamp ON again, although this may be undesirable for other reasons.

In the embodiment as described above, time t2 is selected to coincide with a zero-crossing of the capacitor voltage. The current flowing in the inductor L and decreasing from maximum to zero (inductor fully discharged), however, will charge the capacitor C again, to a voltage which may for instance easily be more than 150 V. As mentioned above, this capacitor voltage adds to the mains voltage.

In a preferred variation, the time t2 is selected slightly earlier than a zero-crossing of the capacitor voltage. In that case, the increasing current through inductor L will not yet have reached its maximum at time t2, and the decreasing capacitor voltage will not yet have reached zero. As from time t2, the continuing inductor current will start decreasing, and the capacitor voltage will continue to decrease but, in view of the decreasing inductor current, at a decreasing rate. It is possible to select t2 at an optimum value such that, at the precise moment when the inductor current reaches zero, the capacitor voltage also reaches zero. From that moment onwards, the voltage over the lamp terminals is just the mains voltage. This optimum value of t2 will be indicated as the “zero approaching” time, because the capacitor voltage approaches zero rather than crosses it.

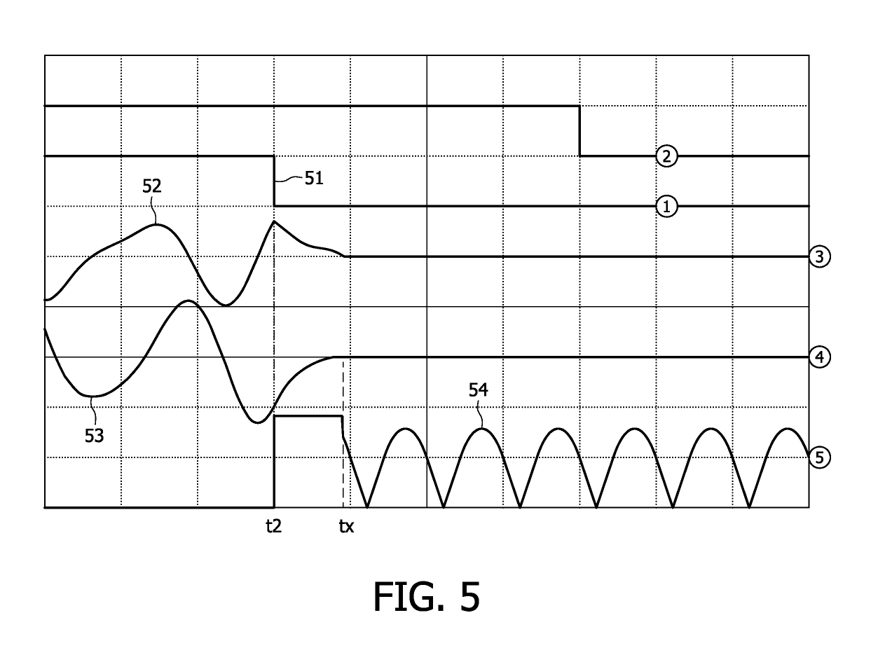

FIG. 5 is a graph illustrating switching at the zero approaching time. The horizontal axis represents time.

Curve 51 represents a control signal S1: at time t2, switch 26 is opened.

Curve 52 represents the inductor current: at time t2, it has passed zero and is rising to reach a maximum, and as from t2 it is decreasing to reach zero at a time tx.

Curve 53 represents the capacitor voltage: at time t2, it has passed a maximum and is decreasing to zero, and as from t2 it continues decreasing but at a decreasing rate to also reach zero at said time tx.

Curve 54 represents the (rectified) lamp voltage: at time t2, it steps from zero to a very high value, clamped by the Zener. As from tx, it is equal to the main voltage, which has a maximum lower than the Zener voltage.

It is noted that the control device 28 is also capable of operating in a lamp-starting mode. To this end, when the lamp is off, the control device 28 will briefly make the first switch 26 conductive and then make this switch non-conductive again, while keeping the second switch 126 non-conductive.

FIG. 4 is a block diagram schematically illustrating a second embodiment of a ballast according to the present invention, generally indicated by the reference numeral 210, having an electronic switching circuit 220, which comprises all elements of the circuit 20 as described above, plus additionally a series arrangement of a Zener diode 227 and a resistor 230 connected between the positive terminal 24 and the control terminal of the switch 26. The Zener diode 227 may be identical to the Zener diode 127 described above.

An advantage of this second embodiment 210 as compared to the first embodiment 110 is that only one switch is required; this one switch 26 effectively performs the functions of the two switches 26 and 126 of the ballast 110.

The control device 28 is again capable of operating in a lamp-extinguishing mode. The operation of the control device 28 is comparable to the operation of the control device in the circuit 20 illustrated in FIG. 2, but the operation of the circuit 220 is comparable to the operation of the circuit 120 illustrated in FIG. 3. With the switch 26 conductive, the lamp current will be deviated from the lamp and passed through the switch 26. When the control device 28 makes the switch 26 non-conductive again, a high-voltage peak between terminals 24 and 25, if exceeding the Zener voltage, is capable of rendering the switch 26 conductive again by applying a suitable bias signal to the control terminal of the switch 26. More particularly, if the voltage over the lamp exceeds the Zener voltage, the Zener diode 227 becomes conductive and the voltage at the gate of switch 26 will rise. If the gate voltage reaches the threshold voltage of the MOSFET 26, it will become conductive. The MOSFET 26 will then operate in its linear mode, where its conductance (and hence its current) is proportional to the gate voltage. With rising current, the voltage between terminals 24 and 25 will tend to become lower. An equilibrium situation with an almost constant voltage between terminals 24 and 25 and an almost constant current through the MOSFET 26 will develop, wherein the MOSFET will dissipate much energy.

In the embodiment of FIG. 3, energy is dissipated in the Zener diode which therefore needs to be a power Zener. In the embodiment of FIG. 4, energy is dissipated in the MOSFET and the Zener diode can be a small signal diode only having the function of defining a voltage reference when the MOSFET will become conductive.

It is noted that, in the embodiment of FIG. 4, it is not necessary to protect the control output of the control circuit 28 against high voltages, because the voltage level at this control output can not become significantly higher than the threshold gate voltage of the MOSFET 26.

It is noted that in the above embodiments the rectifier 21 allows the use of relatively cheap MOSFETs, which should be operated to conduct current in one direction only. Instead, it is in principle possible to another type of controllable switch, capable to be operated with current in two directions, in which case the rectifier can be omitted. Likewise, the Zener-diode can be replaced by any other electronic component or circuitry, capable of maintaining a high impedance if subjected to a voltage lower than a predetermined threshold, and capable of breaking, i.e. switching to a low-impedance state, if subjected to a voltage exceeding said predetermined threshold; such component will be indicated by the general phrase “Zener device”.

Summarizing, the present invention provides an electro magnetic ballast 110; 210 for a gas discharge lamp 2, comprising:
input terminals 3, for receiving a mains voltage;
lamp connector terminals 4, for receiving a lamp;
an impedance connected in series with the lamp connector terminals, the impedance comprising at least an inductor L and preferably comprising a series arrangement of a capacitor C and an inductor L;
an electronic switching circuit 120; 220 having input terminals 22, 23 connected in parallel to the lamp connector terminals;
   wherein the electronic switching circuit 120; 220 comprises:
a rectifier 21 connected to the input terminals 22, 23 and having a positive output terminal 24 and a negative output terminal 25;
switchable voltage clamping and energy dissipating means 126, 127; 26, 27, 227, 230 connected between said positive output terminal 24 and said negative output terminal 25;
and a control circuit 28 for controlling the voltage clamping and energy dissipating means.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, it is noted that the electronic switching circuit can be implemented as a cylindrical housing having two terminals in one end face, to match with an ordinary starter socket such as to be able to replace an ordinary mechanical starter.

Further, although the present invention is conceived and intended for use with a capacitive ballast (LC ballast), its use is not limited to such ballast type: the invention can also be used in the case of an inductive ballast (L ballast). In that case, the timing may be identical to the prior art timing.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Electro magnetic ballast (110; 210) for a gas discharge lamp (2), comprising:
input terminals (3), for receiving a mains voltage;
lamp connector terminals (4), for receiving a lamp;
an impedance connected in series with the lamp connector terminals, the impedance comprising at least an inductor (L) and preferably comprising a series arrangement of a capacitor (C) and an inductor (L);
an electronic switching circuit (120; 220) having input terminals (22, 23) connected in parallel to the lamp connector terminals;
wherein the electronic switching circuit (120; 220) comprises:
switchable voltage clamping and energy dissipating means (126, 127; 26, 27, 227, 230) for clamping the voltage over said lamp connector terminals to a predetermined reference voltage lower than a lamp ignition voltage;
and a control circuit (28) for controlling the voltage clamping and energy dissipating means.

2. Electro magnetic ballast according to claim 1, wherein the electronic switching circuit comprises a rectifier (21) connected to the input terminals (22, 23) and having a positive output terminal (24) and a negative output terminal (25);
wherein said switchable voltage clamping and energy dissipating means (126, 127; 26, 27, 227, 230) are connected between said positive output terminal (24) and said negative output terminal (25).

3. Electro magnetic ballast according to claim 1, wherein the switchable voltage clamping and energy dissipating means comprise a series arrangement of a first controllable switch (126) and a Zener device (127).

4. Electro magnetic ballast according to claim 3, wherein the electronic switching circuit further comprises a series arrangement of a second controllable switch (26) and a current sensor (27);
wherein the control circuit (28) is capable of operating in a normal mode in which both switches (26, 126) are non-conductive;
and wherein the control circuit (28) is capable of operating in a lamp-extinguishing mode in which the control circuit, in a situation when the lamp is ON, temporarily renders the second switch (26) conductive and temporarily renders the first switch (126) conductive.

5. Electro magnetic ballast according to claim 4, wherein the control circuit (28) renders the first switch (126) conductive at the same time as the second switch (26) is rendered conductive, or later but before the second switch (26) is rendered non-conductive again.

6. Electro magnetic ballast according to claim 4, wherein the control circuit (28) renders the first switch (126) non-conductive again later than the second switch (26) is rendered non-conductive again.

7. Electro magnetic ballast according to claim 4, wherein the impedance comprises a series arrangement of a capacitor (C) and an inductor (L), and wherein the control circuit (28) renders the first switch (126) non-conductive again coinciding with or slightly earlier than a zero-crossing of the voltage of capacitor C.

8. Electro magnetic ballast according to claim 7, wherein the control circuit (28) renders the first switch (126) non-conductive again at a “zero approaching” time.

9. Electro magnetic ballast according to claim 2, wherein the Zener device has a Zener voltage lower than the ignition voltage of the lamp.

10. Electro magnetic ballast according to claim 2, wherein the switchable voltage clamping and energy dissipating means comprise a series arrangement of a controllable switch (26) and a current sensor (27) connected between said positive output terminal (24) and said negative output terminal (25), and further comprise a series arrangement of a Zener diode (227) and a resistor (230) connected between a control input terminal of the switch (26) and one of said output terminals (24, 25).

11. Electro magnetic ballast according to claim 10, wherein the control circuit (28) is capable of operating in a normal mode in which said switch (26) is non-conductive;
and wherein the control circuit (28) is capable of operating in a lamp-extinguishing mode in which the control circuit, in a situation when the lamp is ON, temporarily generates a control signal (S1) for rendering the switch (26) conductive.

12. Electro magnetic ballast according to claim 11, wherein the impedance comprises a series arrangement of a capacitor (C) and an inductor (L), and wherein the control circuit (28) terminates is control signal (S1) at a moment (t2) coinciding with or slightly earlier than a zero-crossing of the voltage of capacitor C.

13. Electro magnetic ballast according to claim 12, wherein the control circuit (28) terminates is control signal (S1) at a “zero approaching” time.

14. Electro magnetic ballast according to claim 11, wherein the Zener device has a Zener voltage lower than the ignition voltage of the lamp.

15. Electro magnetic ballast according to claim 11, wherein the Zener device is mounted such that a voltage difference between said output terminals (24, 25) higher than the Zener voltage will cause the switch (26) to become conductive.
